(19) United States
(12) Patent Application Publication
(10) Pub. No.: US 2009/0191446 A1
(43) Pub. Date: Jul. 30, 2009

(54) Method of producing a sealing arrangement for a fuel cell unit and a sealing arrangement for a fuel cell unit

(75) Inventors: Uwe Maier, Reutlingen (DE); Thomas Kiefer, Ettlingen (DE)

Correspondence Address: Edward J. Timmer, P.O. Box 770, Richland, MI, 49083, US

(73) Assignee: ElringKlinger AG

(21) Appl. No.: 12/148,626

(22) Filed: Apr. 21, 2008

Related U.S. Application Data
(63) Continuation of application No. PCT/EP2008/000592, filed on Jan. 25, 2008.

(51) Int. Cl. H01M 2/08; B05D 5/12; C25D 5/48

(52) U.S. Cl. 429/35; 427/115; 205/220

(57) ABSTRACT

In order to provide a method of producing a sealing arrangement for a fuel cell unit by means of which there can be produced a sealing arrangement having good gas-tight properties and good electrical insulation and which exhibits long-term stability in operation of a fuel cell system, there is proposed a method of producing a sealing arrangement for a fuel cell unit which comprises the following process steps:
coating a base material of a component with an oxidizable coating material;
letting the coating material diffuse into the base material;
oxidizing the coating material for the purposes of producing an oxide layer which has a surface resistivity of at least 1.kQ cm² at the operating temperature of the fuel cell unit.

### RELATED APPLICATION

This application is a continuation application of PCT/EP2008/000592 filed on Jan. 25, 2008, the entire specification of which is incorporated herein by reference.

### FIELD OF DISCLOSURE

The present invention relates to a method of producing a sealing arrangement for a fuel cell unit.

### BACKGROUND

The production of suitable sealing systems occupies a central position in the development of high temperature fuel cell systems (so-called SOFC fuel cells). Such sealing systems must satisfy the high demands made in regard to a gas-tight seal, electrical insulation, chemical stability and tolerance in relation to mechanical loads (in particular, during thermal cycles).

It is already known to employ solder glass seals for sealing purposes in fuel cell systems. Such solder glass seals exhibit good gas-sealant properties, electrical insulation and chemical stability. The solder glass softens during the jointing cycle, before it crystallizes and hardens. The sealing gap of the solder glass seal can be set by means of ceramic spacers. The usual widths hereby lie within a range of 300 μm±50 μm.

However, such solder glass seals only exhibit low tolerances in relation to the mechanical load during thermal cycles due to their poor heat conductivity and the brittle behaviour of the material.

Furthermore, it is known to employ metal braze seals for sealing purposes in fuel cell systems. Such metal braze seals have advantages particularly in regard to the thermal cycles due to their ductile behaviour. However, the metal braze is unsuitable as an electrical insulator and for this reason an additional insulating layer must be provided. For example, it is known to use an aluminium magnesium spinel layer produced in a vacuum plasma spraying process as an insulating layer.

The production of such an insulating layer by means of the vacuum plasma spraying process is however a complex and cost-intensive processing step. Due to the tolerances inherent to the production process, it is accordingly necessary to adopt high safety factors, this thereby resulting in the layer thickness of the insulating layer being high with a concomitant increase in the consumption of materials. Moreover, a thicker insulating layer of the aluminium magnesium spinel, which has a different coefficient of thermal expansion from that of the steel materials used in the fuel cell unit, induces internal stresses. These internal stresses can cause fractures and thus leakages in the fuel cell system.

In the case of both solder glass seals and metal braze seals, the adherence of the braze layer to the components requiring sealing is of critical importance. Particularly over a long period of operation of the fuel cell system, the boundary surface between the steel material and the braze material changes due to the constantly growing oxide layer on the components of the fuel cell unit consisting of steel material, and this can lead to a loss of adhesion between the braze material and the steel material.

### SUMMARY OF THE INVENTION

The object of the present invention is to provide a method of producing a sealing arrangement for a fuel cell unit by means of which there can be produced a sealing arrangement having good gas-tight properties and a high level of electrical insulation and which has long-term stability over the operating life of a fuel cell system.

In accordance with the invention, this object is achieved by a method of producing a sealing arrangement for a fuel cell unit which comprises the following process steps:
coating a base material of a component with an oxidizable coating material;
letting the coating material diffuse into the base material;
oxidizing the coating material for the purposes of producing an oxide layer which has a surface resistivity of at least 1 kΩ·cm² and preferably of at least 5 kΩ·cm² at the operating temperature of the fuel cell unit (within a range of 600° C. to 800° C.).

The concept underlying the invention is that of coating at least one of the two components of a fuel cell system that are to be interconnected by the sealing arrangement with an oxidizable coating material, letting this coating material partially diffuse into the base material of the coated component, and then oxidizing the coating material for the purposes of producing an oxide layer and finally connecting the at least one component provided with the oxide layer to the other respective component in order to thereby produce the sealing arrangement for the fuel cell unit.

By virtue of this production process which comprises a diffusion step and a following oxidation step, the layer consisting of the coating material that has been applied to the base material grows into the base material so that the coating material and the oxide layer produced therefrom are firmly anchored in the base material. Due to this anchorage, the adherence of the oxide layer is improved compared with the known sealing systems. The composite consisting of the oxide layer and the base material can thereby be subjected to higher mechanical loads, in particular, during the thermal cycles of the fuel cell system.

Moreover, due to the diffusion step, the effect is achieved that the material properties, and in particular the hardness, exhibit a gradient. Thus, the oxide layer is hard (brittle), the base material (steel) is soft (ductile) and the intermediate diffusion layer is hard/soft (brittle/ductile).

Furthermore, due to the growth of the coating material and the oxide layer formed therefrom into the base material, the surface of the base material and in particular its oxidation behaviour are modified. The oxidation behaviour of the base material is affected in such a way by the oxide layer that adherence of the oxide layer to the base material is ensured even over long-term operation of the fuel cell system.

A metallic coating material is preferably used as the oxidizable coating material.

In a preferred embodiment of the invention, provision is made for the coating material to comprise aluminium or an aluminium alloy.

Various methods can be envisaged for the process of applying the coating material to the base material.

Thus, for example, provision can be made for the base material to be coated with the coating material by means of a plating process.

As an alternative or in addition thereto, the base material can be coated with the coating material by means of an electroplating process.

As an alternative or in addition thereto, provision could also be made for the base material to be coated with the coating material by means of a PVD (Physical Vapour Deposition) process or a CVD (Chemical Vapour Deposition) process.

In the case where aluminium or an aluminium alloy is used for the coating process, provision could also be made for the base material to be coated with the coating material by a hot-dip aluminising process.

In principle, any suitable oxidation process could also be envisaged for carrying out the process of oxidising the coating material.

For example, the coating material can be oxidized by heating it in an oxygen-containing atmosphere.

In particular, the coating material can be oxidized by a temperature treatment in air.

Particularly good anchorage of the thus produced oxide layer in the base material is achieved if the coating material is oxidized by means of an anodising process.

For the purposes of producing the sealing arrangement, the oxide layer is preferably connected firmly to another component of the same fuel cell unit or of a neighbouring fuel cell unit.

This other component may likewise, but not necessarily, be provided with an oxide layer.

In a preferred embodiment of the invention, provision is made for the oxide layer to be brazed to the other component.

Since a metallic braze has advantages during the thermal cycles of the fuel cell system due to its ductile behaviour, it is expedient if the oxide layer is brazed to the other component by means of a metallic braze.

Hereby, the requisite electrically insulating effect of the sealing arrangement is ensured due to the surface resistivity of the oxide layer being sufficiently high.

It has proven to be particularly expedient, if the oxide layer is brazed to the other component by means of a metallic braze having a silver basis, a copper basis and/or a nickel basis.

The method of producing a sealing arrangement for a fuel cell unit in accordance with the invention is particularly suitable in the case where the base material comprises a steel material forming chromium oxide.

The electrically insulating oxide layer produced by means of the method in accordance with the invention is preferably an aluminium oxide layer, an aluminium magnesium spinel layer, a stabilized (especially yttrium-stabilized) zirconium oxide layer or a magnesium oxide layer.

The coating material can contain an additive of boron, lithium, niobium and/or magnesium in order to match the coefficient of thermal expansion a of the oxide layer that has been produced to the coefficient of thermal expansion of the base material.

Preferably, the additive of boron, lithium, niobium and/or magnesium is measured in such a way that the coefficient of thermal expansion a of the oxide layer that has been produced lies within a range of approximately 10·10⁻⁶K⁻¹ to approximately 20·10⁻⁶K⁻¹, preferably within the range of approximately 11.5·10⁻⁶K⁻¹ to approximately 13.5·10⁻⁶K⁻¹.

A material additive may already be incorporated in the coating material prior to the base material being coated with the coating material.

As an alternative or in addition thereto, provision can also be made for a material additive to be added to the coating material after the base material has been coated with the coating material.

Such subsequent addition of a material additive to the coating material can be effected, in particular, by means of a PVD (Physical Vapour Deposition) process or by means of a CVD (Chemical Vapour Deposition) process.

Furthermore, the present invention relates to a sealing arrangement for a fuel cell unit.

The further object of the present invention is to produce a sealing arrangement which is such as to provide long-term stability in operation of the fuel cell system and which ensures good gas-tight properties and good electrical insulation.

In accordance with the invention, this object is achieved by a sealing arrangement for a fuel cell unit which comprises the following:
a first component made from a base material;
an oxide layer which has a surface resistivity of at least 5 kΩ·cm² at the operating temperature of the fuel cell unit and is formed by oxidation of a coating material; and
a diffusion layer which comprises a gradient of the coating material and is arranged between the base material and the oxide layer.

Due to the diffusion layer arranged between the base material and the oxide layer, the oxide layer is anchored in the base material in such a way that good adherence of the oxide layer is ensured even when the fuel cell system has been in operation for a long period.

Particular developments of the sealing arrangement in accordance with the invention form the subject matter of Claims 18 to 28, the features and advantages thereof having already been explained in connection with the particular developments of the method in accordance with the invention.

The sealing arrangement in accordance with the invention is suitable, in particular, for use in a high temperature fuel cell, in particular, an SOFC (Solid Oxide Fuel Cell) having an operating temperature of at least 600° C. for example.

Further features and advantages of the invention form the subject matter of the following description and the graphical illustration of exemplary embodiments.

### BRIEF DESCRIPTION OF THE DRAWINGS

FIG. 1 shows a schematic illustration of the successive process steps a) to f) used in a method of producing a sealing arrangement for a fuel cell unit; and

FIG. 2 a schematic illustration of a rolling process for coating a base material with a coating material.

Similar or functionally equivalent elements are designated by the same reference symbols in each of the Figures.

### DETAILED DESCRIPTION OF THE INVENTION

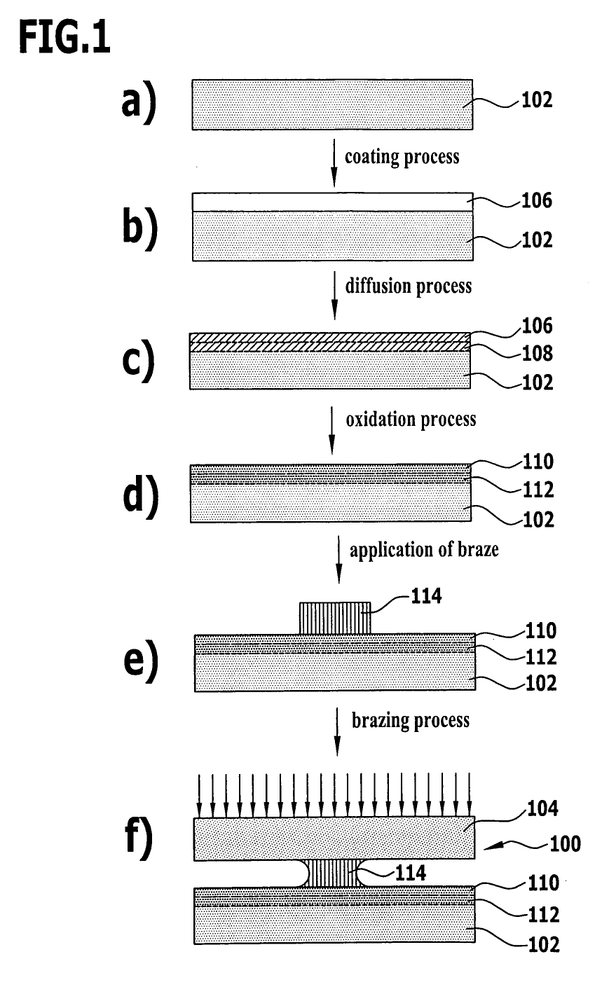

A method of producing a sealing arrangement bearing the general reference 100 for connecting a first metallic component 102 and a second metallic component 104 of a fuel cell unit in fluid-tight and electrically insulating manner is schematically represented in FIG. 1 and comprises the process steps:
a) providing the first component 102 consisting of a metallic base material;
b) coating the base material with an oxidizable coating material 106;
c) partially diffusing the coating material into the base material for the purposes of forming a diffusion layer 108 between the base material and the coating layer 106;
d) oxidizing the coating material for the purposes of forming an oxide layer 110 and an oxidized intermediate layer 112;
e) applying a metallic braze material 114 to the free surface of the oxide layer 110;
f) brazing the metallic second component 104 to the oxide layer 110 on the first component 102 by means of the braze material 114 which is liquefied during the brazing process whilst applying a contact pressure which is indicated by the arrows 116 in FIG. 1f).

The first component 102 may, for example, be an upper housing part of a housing for a fuel cell unit, and the second component 104 may be a lower housing part of a further fuel cell unit which follows the first fuel cell unit in the stack direction of a fuel cell stack.

Such fuel cell units having two-piece housings which are composed of a lower housing part and an upper housing part are disclosed in DE 103 58 458 A1 for example, to which reference is made in this respect and which is incorporated by reference in this application.

The first component 102 and/or the second component 104 can serve, in particular, as a bipolar plate or interconnector in the fuel cell unit.

The pre-prepared first component 102 can comprise a steel forming chromium oxide (Cr₂O₃) as the base material.

In particular, the following steels forming chromium oxide are suitable as the base material for the first component 102 (and likewise for the second component 104):
The steel bearing the designation Crofer22APU from the manufacturer ThyssenKrupp AG, Germany, having the following composition:
   22.2 percentage weight Cr; 0.02 percentage weight Al; 0.03 percentage weight Si; 0.46 percentage weight Mn; 0.06 percentage weight Ti; 0.002 percentage weight C; 0.004 percentage weight N; 0.07 percentage weight La; 0.02 percentage weight Ni; the remainder iron.
The steel bearing the designation F17TNb from the manufacturer Imphy Ugine Precision, France, having the following composition:
   17.5 percentage weight Cr; 0.6 percentage weight Si; 0.24 percentage weight Mn; 0.14 percentage weight Ti; 0.17 percentage weight C; 0.02 percentage weight N; 0.47 percentage weight Nb; 0.08 percentage weight Mo; the remainder iron.
   The steel bearing the designation F17TNb has the material designations 1,4509 according to EN, 441 according to AISI and S44100 according to UNS.
The steel bearing the designation IT-11 from the manufacturer Plansee AG, Austria, having the following composition:
   25.9 percentage weight Cr; 0.02 percentage weight Al; 0.01 percentage weight Si; 0.28 percentage weight Ti; 0.08 percentage weight Y; 0.01 percentage weight C; 0.02 percentage weight N; 0.01 percentage weight Mo; 0.16 percentage weight Ni; the remainder iron.
The steel bearing the designation Ducrolloy (ODS) from the manufacturer Plansee AG, Austria, having the following composition:
   5.5 percentage weight Fe; 0.48 percentage weight Y; 0.01 percentage weight C; 0.01 percentage weight N; the remainder Cr.

The base material of the first component 102 consisting of one of the aforementioned steels is provided with a coating of aluminium or an aluminium alloy.

This coating can, for example, be provided by means of an electroplating process, a hot-dip aluminising process, a PVD (Physical Vapour Deposition) process, a CVD (Chemical Vapour Deposition) process, a thermal spraying process (preferably under an inert gas), in particular, a vacuum plasma spraying process, or by means of a plating process, in particular, a rolling process.

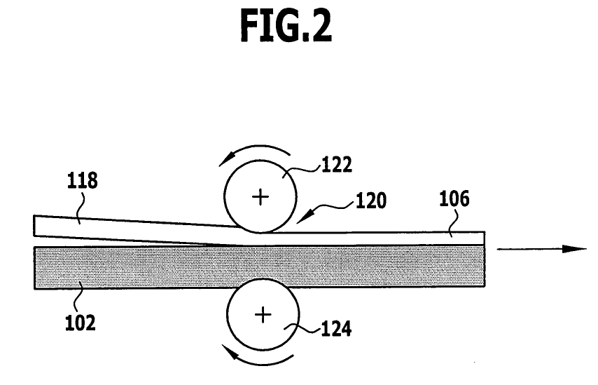

In FIG. 2, there is a schematic illustration of how a film 118 consisting of the coating material is fed together with a metal sheet consisting of the base material of the first component 102 through a roller gap 120 between two counter-rotating rollers 122 and 124 and is connected in this way to the base material by the rolling process.

The film 118 can, in particular, be formed from aluminium or an aluminium alloy.

Furthermore, the film 118 can contain additives of magnesium, lithium, boron and/or niobium that are embedded in a basic matrix, of aluminium for example, in order to match the coefficient of thermal expansion of the subsequently formed oxide layer 110 to the thermal coefficient of the base material of the first component 102 and thus to the coefficient of thermal expansion of other elements of the fuel cell unit.

After the coating process, a diffusion process is carried out on the base material with the coating material 106 arranged thereon.

To this end, the base material together with the coating material 106 arranged thereon are heated up in a diffusion oven to a diffusion temperature within a range of approximately 500° C. to approximately 1,000° C. for example. This diffusion temperature is maintained for a diffusion time of from approximately 1 hour to approximately 6 hours for example.

The diffusion process can be carried out in a standard atmosphere or in an inert gas atmosphere, for example, in an argon atmosphere having an additive of five mol-percent H₂.

During this diffusion process, the coating material 106 partially diffuses into the base material so that an intermediate layer 108, in which the concentration of the coating material gradually decreases from the coated side, develops between the base material of the first component 102 and the coating material 106.

Due to this intermediate layer 108, the coating is firmly anchored in the base material of the first component 102.

Furthermore, due to the growth of the coating into the steel base material, the steel surface and the oxidation behaviour thereof are modified.

After the diffusion process, oxidation of the oxidizable coating material is carried out.

This oxidation process can be effected by means of an anodising process for example.

The anodising process can, for example, be carried out using a sulphuric acid treatment, an oxalic acid treatment or a chromic acid treatment.

An anodising process that is particularly suitable for oxidising the coating material and which is described in more detail hereinafter is the direct current, sulphuric acid-oxalic acid process.

Here, the component requiring anodising is degreased in a first step by placing the component into a degreasing medium consisting of alkalis, silicates, phosphates and/or surfactants which is dissolved in distilled water (DI water) at a concentration of from 3 to 5 percentage weight of the medium.

The degreasing process is carried out at a temperature of from approximately 60° C. to approximately 80° C. and with a pH value of from approximately 11 to approximately 13 for a degreasing period of from approximately 1 minute to approximately 3 minutes.

After the degreasing step, the component requiring anodising is rinsed. Distilled water (DI water) is used as the rinsing agent. The rinsing process takes place at room temperature for a rinsing period of approximately 1 minute for example.

After this first rinsing step, the component requiring anodising is subjected to an etching step.

A solution of 80 g Na₂CO₃ and 15 g NaF in 900 g distilled water (DI water) for example is used as the etching agent.

The component requiring anodising is etched in this etching solution at an etching temperature of approximately 50° C. for example, for a treatment time of approximately 1.5 minutes for example.

After the etching step, the component requiring anodising is subjected to a second rinsing step.

Here, the component is rinsed with distilled water (DI water) at room temperature for a rinsing period of approximately 1 minute for example.

After this second rinsing step, the component requiring anodising is anodised, i.e. it is immersed in an electrolyte as an anode and oxidized by the flow of current.

A mixture made up of approximately 10-15% sulphuric acid and approximately 1-2% oxalic acid is used as the electrolyte medium.

A direct current having a current-density of from approximately 1 A/dm² to approximately 2 A/dm² at a DC voltage of from approximately 20 V to approximately 25 V is passed through the electrode.

The temperature of the electrolyte amounts to approximately 20° C. to approximately 25° C. for example.

The anodising time period amounts to up to 20 minutes in dependence on the thickness of the coating material so that substantially all of the oxidizable coating material is oxidized.

After the anodising step, the anodised component is subjected to a third rinsing step.

Hereby, the component is rinsed with distilled water (DI water) at room temperature for a rinsing period of approximately 1 minute for example. If necessary, a subsequent treatment with hot distilled water can be carried out.

If additives for the coating material 106, which are intended to match the coefficient of thermal expansion of the subsequently produced oxide layer 110 to the coefficient of thermal expansion of the base material, are not yet contained in the film 118 that was rolled onto the base material, then these additives can be introduced into the coating material 106, after the film 118 has been rolled on, by means of a PVD (Physical Vapour Deposition) process or a CVD (Chemical Vapour Deposition) process for example.

Such additives can, in particular, be additives of magnesium, lithium, boron and/or niobium.

The oxide layer 110 produced by the anodising process has a surface resistivity of at least 1 ΩQ·cm² and preferably of at least 5 kg cm² at the operating temperature of the fuel cell unit (in particular at a temperature of 800° C.).

This electrically insulating oxide layer 110 is connected to the second component 104 by means of a metallic braze.

To this end, the metallic braze material is applied to the free surface of the oxide layer 110 in a braze application step.

The braze application process can be effected by means of a silk-screen printing process for example.

To this end, for example, a screen having a mesh density of 18 mesh/cm² and a mesh width of approximately 0.18 mm can be used.

The wet layer thickness of the applied braze material can amount to approximately 100 μm for example.

The brazing width of the applied braze material can amount to approximately 2 mm for example.

Suitable metallic braze materials are, for example, a nickel based braze, a copper based braze or a silver based braze.

In particular, the following are suitable braze materials:
The nickel based braze with the designation NI 102 in accordance with DIN EN 1044, having the following composition: 7 percentage weight Cr; 4.5 percentage weight Si; 3.1 percentage weight B; 3.0 percentage weight Fe; less than 0.06 percentage weight C; less than 0.02 percentage weight P; the remainder Ni.
The copper based braze with the designation CU 202 in accordance with DIN EN 1044, having the following composition: 12 percentage weight Sn; 0.2 percentage weight P; the remainder Cu.
The silver based braze with the designation Ag4CuO which is sold by the company Innobraze GmbH, Germany, under the Article number PA 9999999, having the following composition: 96 mol % Ag; 4 mol % CuO.
   Following the application of the braze material to the oxide layer 110 or, as an alternative thereto, to a free surface of the second component 104 requiring brazing, the first component 102 and the second component 104 are pressed against each other for a brazing process using a surface loading of approximately 0.25 N/cm² for example (taken with respect to a brazing surface of 12 cm² and an applied weight of 4 kg for example), and the brazing point is heated up in accordance with the following temperature profile:
heating at a speed of approximately 100 K/h to a brazing temperature of approximately 1,010° C. for example;
maintaining the brazing temperature for a period of approximately 30 minutes;
following this maintenance period, cooling at a speed of approximately 40 K/h to room temperature.

In consequence, the production of the sealing arrangement 100 consisting of the first component 102, the second component 104, the oxide layer 110 and the braze material 114 is completed.

The leakage rate of this sealing arrangement 100 amounts to maximally 0.001 Pa·l/s·cm.

In the manufacturing process described above, at least one of the two steel substrates that are to be jointed together (the first component 102, the second component 104) is metallically coated. This coating is partially diffused into the steel substrate. Subsequently, the coating is anodised and connected to the respective other steel substrate.

Thereby the following advantages result:

Due to the diffusion step and the oxidation step, the oxide layer produced grows into the steel substrate. The adherence of the oxide layer is improved due to this anchorage in the steel substrate so that the composite consisting of the oxide layer and the base material can be subjected to higher mechanical loads, in particular, during thermal cycles.

Moreover, due to the diffusion step, the effect is achieved that the material properties, in particular, the hardness, exhibit a gradient. Thus, the oxide layer is hard (brittle), the base material (steel) soft (ductile) and the intermediate diffusion layer hard/soft (brittle/ductile).

Furthermore, due to the growth of the oxide layer into the steel, the surface of the steel substrate and the oxidation behaviour thereof are modified. In particular, the oxidation behaviour of the steel substrate is affected in such a way that adherence of the oxide layer can be ensured even in long-term operation of the fuel cell unit.

The coefficient of thermal expansion a of the oxide layer 110 lies within a range of approximately 12·10⁻⁶ K⁻¹ to approximately 13·10⁻⁶ K⁻¹ and is thereby approximately equally as great as the coefficient of thermal expansion of the base material of the first component 102 and the second component 104.

1. A method of producing a sealing arrangement for a fuel cell unit, comprising the following process steps:
coating a base material of a component with an oxidizable coating material;
letting the coating material diffuse into the base material;
oxidizing the coating material for the purposes of producing an oxide layer which has a surface resistivity of at least 1 kΩ·cm² at the operating temperature of the fuel cell unit.

2. A method in accordance with claim 1, wherein the coating material comprises aluminium or an aluminium alloy.

3. A method in accordance with claims 1, wherein the base material is coated with the coating material by a plating process.

4. A method in accordance with claim 1, wherein the base material is coated with the coating material in an electroplating process.

5. A method in accordance with claim 1, wherein the base material is coated with the coating material by means of a PVD or a CVD process.

6. A method in accordance with claim 2, wherein the base material is coated with the coating material by a hot-dip aluminising process.

7. A method in accordance with claim 1, wherein the coating material is oxidized by a temperature treatment in air.

8. A method in accordance with claim 1, wherein the coating material is oxidized by an anodising process.

9. A method in accordance with claim 1, wherein the oxide layer is firmly connected to another component.

10. A method in accordance with claim 9, wherein the oxide layer is brazed to the other component.

11. A method in accordance with claim 10, wherein the oxide layer is brazed to the other component by means of a metallic braze.

12. A method in accordance with claim 11, wherein the oxide layer is brazed to the other component by means of a metallic braze having a silver, copper and/or nickel basis.

13. A method in accordance with claim 1, wherein the base material comprises a steel material forming chromium oxide.

14. A method in accordance with claim 1, wherein the oxide layer is an aluminium oxide layer, an aluminium magnesium spinel layer, a stabilized zirconium oxide layer or a magnesium oxide layer.

15. A method in accordance with claim 1, wherein the coating material contains an additive of boron, lithium, niobium and/or magnesium.

16. A method in accordance with claim 1, wherein a material additive is added to the coating material after the base material has been coated with the coating material.

17. A sealing arrangement for a fuel cell unit, comprising
a first component made from a base material;
an oxide layer which has a surface resistivity of at least 1 kΩ·cm² at the operating temperature of the fuel cell unit and is formed by oxidation of a coating material; and
a diffusion layer which comprises a gradient of the coating material and is arranged between the base material and the oxide layer.

18. A sealing arrangement in accordance with claim 17, wherein the coating material comprises aluminium or an aluminium alloy.

19. A sealing arrangement in accordance with claim 17, wherein the oxide layer is formed by a temperature treatment of the coating material in air.

20. A sealing arrangement in accordance with claim 17, wherein the oxide layer is formed by anodising the coating material.

21. A sealing arrangement in accordance with claim 17, wherein the sealing arrangement comprises a further component which is firmly connected to the oxide layer.

22. A sealing arrangement in accordance with claim 21, wherein the oxide layer is brazed to the further component.

23. A sealing arrangement in accordance with claim 22, wherein the oxide layer is brazed to the further component by means of a metallic braze.

24. A sealing arrangement in accordance with claim 23, wherein the oxide layer is brazed to the further component by means of a metallic braze having a silver, copper and/or nickel basis.

25. A sealing arrangement in accordance with claim 17, wherein the base material comprises a steel material forming chromium oxide.

26. A sealing arrangement in accordance with claim 17, wherein the oxide layer comprises an aluminium oxide layer, an aluminium magnesium spinel layer, a stabilized zirconium oxide layer or a magnesium oxide layer.

27. A sealing arrangement in accordance with claim 17, wherein the oxide layer contains an additive of boron, lithium, niobium and/or magnesium.

28. A sealing arrangement in accordance with claim 17, wherein the coefficient of thermal expansion a of the oxide layer amounts to approximately 10·10⁻⁶ K⁻¹ to approximately 20·10⁻⁶·K⁻¹.
